(19) United States
(12) Patent Application Publication
(10) Pub. No.: US 2019/0194030 A1
(43) Pub. Date: Jun. 27, 2019

(54) METHOD OF PREPARING NANOSHEET TUNGSTEN DISULFIDE

(71) Applicant: Henan University, Kaifeng (CN)

(72) Inventors: Shengmao ZHANG, Kaifeng (CN); Zhengquan JIANG, Kaifeng (CN); Yujuan ZHANG, Kaifeng (CN); Pingyu ZHANG, Kaifeng (CN); Zhijun ZHANG, Kaifeng (CN)

(21) Appl. No.: 16/290,940

(22) Filed: Mar. 3, 2019

Related U.S. Application Data
(63) Continuation-in-part of application No. PCT/CN2018/084218, filed on Apr. 24, 2018.

(30) Foreign Application Priority Data
Jun. 22, 2017 (CN) 201710479587.2

(51) Int. Cl. C01G 41/00; C10M 125/22

(52) U.S. Cl. CPC C01G 41/00; C10M 125/22; B82Y 30/00; C01P 2002/72; C01P 2004/04; C01P 2004/24

(57) ABSTRACT

A method of preparing a nanosheet tungsten disulfide. The method includes: heating a mixture including tungsten hexachloride, a sulfur source, and a surface modifier to a temperature of between 100 and 200° C. for at least 60 min. The sulfur source is thioacetamide or thiourea. The surface modifier is a C₆₋₄₀ straight-chain or branched fatty acid, aliphatic amine, or a mixture thereof.

### CROSS-REFERENCE TO RELATED APPLICATIONS

This application is a continuation-in-part of International Patent Application No. PCT/CN2018/084218 with an international filing date of Apr. 24, 2018, designating the United States, now pending, and further claims foreign priority benefits to Chinese Patent Application No. 201710479587.2 filed Jun. 22, 2017. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

This disclosure relates to a method of preparing nanosheet tungsten disulfide.

A nanosheet is a nanostructure with a thickness ranging from about 1 to about 100 nm.

A conventional method of preparing tungsten disulfide nanoparticles includes decomposing ammonium tetrathiotungstate at temperatures higher than 360° C. The reaction requires relatively expensive process equipment. Hydrogen sulfide is produced as an intermediate, which is not environmentally friendly. Also, the nanosheets obtained from the conventional process are difficult to disperse in a liquid medium.

### SUMMARY

Disclosed is a method of preparing a nanosheet tungsten disulfide. The method is cost-effective, and the produced nanosheets are stable, and easy to disperse in organic solvents.

The disclosure provides a method of preparing a nanosheet tungsten disulfide. The method comprises: heating a mixture comprising tungsten hexachloride, a sulfur source, and a surface modifier to a temperature of between 100 and 200° C. for at least 60 min. The sulfur source is thioacetamide or thiourea. The surface modifier is a C₆₋₄₀ straight-chain or branched fatty acid, aliphatic amine, or a mixture thereof.

The molar ratio of the tungsten hexachloride to the thioacetamide or thiourea can be 1:2, and the weight ratio of the tungsten hexachloride to the surface modifier can be 1:50. That the molar ratio of the tungsten hexachloride to the thioacetamide or thiourea is 1:2 can ensure the purity of the produced tungsten disulfide. That the weight ratio of the tungsten hexachloride to the surface modifier is 1:50 can ensure the produced tungsten disulfide is easy to disperse.

The method employs tungsten hexachloride as a tungsten source, thioacetamide or thiourea as an active sulfur source. The sources are mixed at 100-200° C. in the presence of a surface modifier to yield a nanosheet tungsten disulfide. The method introduces no anions to the reaction system, and the by-products can be easily removed, which greatly reduces the production cost. Compared with the conventional preparation methods implemented at high temperatures (300-360° C.), the reaction conditions of the method in the disclosure are mild.

Advantages of the method of preparing a nanosheet tungsten disulfide as described in the disclosure are summarized as follows. The method is safe, eco-friendly, low-cost, and easy to operate; the raw material is inexpensive and easily available; the reaction conditions are mild, and the yield of the nanosheet tungsten disulfide is high. The prepared nanosheet tungsten disulfides have uniform particle size and are easy to disperse in the organic solvent, and has broad application prospects in lubricating oil Nano-Additives and other fields.

### BRIEF DESCRIPTION OF THE DRAWINGS

FIG. 1 is an X-ray diffraction (XRD) of a nanosheet tungsten disulfide prepared according to a method of preparing a nanosheet tungsten disulfide as described in the disclosure; and

FIG. 2 is a transmission electron microscope (TEM) image of a nanosheet tungsten disulfide prepared according to a method of preparing a nanosheet tungsten disulfide as described in the disclosure.

### DETAILED DESCRIPTION

To further illustrate, embodiments detailing a method of preparing a nanosheet tungsten disulfide are described below. It should be noted that the following embodiments are intended to describe and not to limit the disclosure.

### Example 1

3.9656 g of tungsten hexachloride, 20 g of oleylamine, and 10 g of octadecene were added to a 500-mL flask. The resulting mixture was heated to 140° C., held for 10 min, followed by addition of 5 g of an oleylamine solution comprising 1.5026 g of thioacetamide. The mixture was heated to 200° C., and the temperature was held for 3 hours. The produced product was centrifuged and washed with ethyl alcohol, to yield a black semisolid paste, that is, a nanosheet tungsten disulfide.

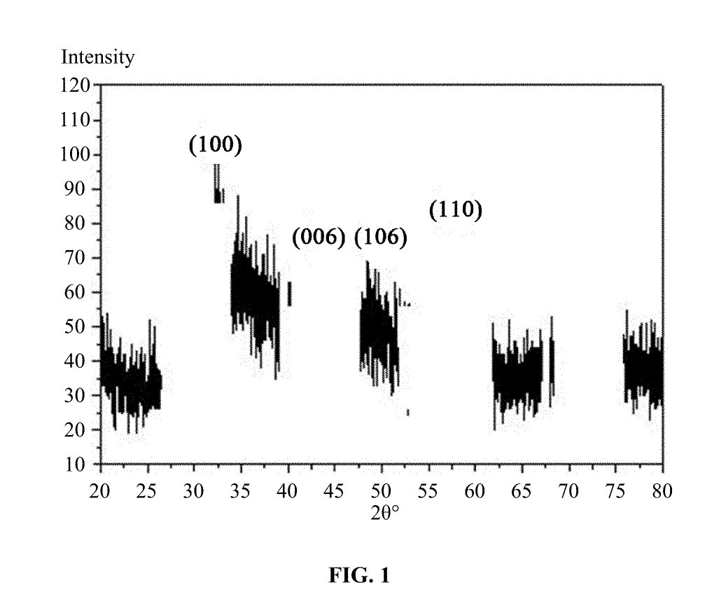

FIG. 1 is an X-ray diffraction of the nanosheet tungsten disulfide. In the figure, the diffraction peaks at 32.665°, 49.087° and 57.424° are identical to the Joint Committee on Powder Diffraction Standards (JCPDF, 08-0237) of tungsten disulfide, and correspond to the characteristic diffraction planes (100), (105), and (110) of ammonium dithiotungstate, respectively. The results show that the tungsten disulfide is successfully prepared and has a two-dimensional lamellar structure.

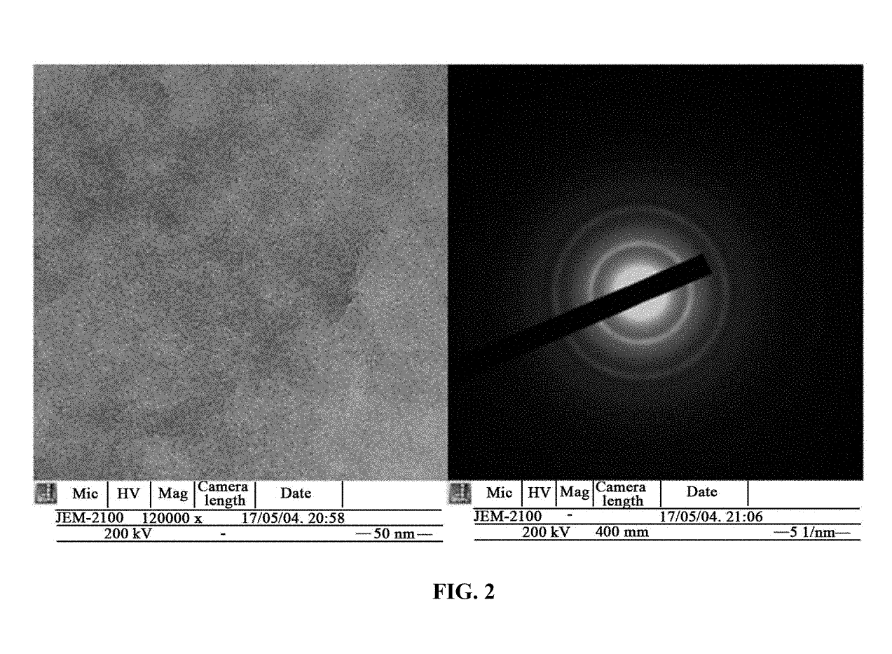

FIG. 2 is a transmission electron microscope (TEM) image of the nanosheet tungsten disulfide. As shown in FIG. 2, the prepared nanosheet tungsten disulfide has uniform particle sizes. The high resolution image shows that the synthesized product is well-crystallized and has a lamellar structure. The selected area electron diffraction pattern (SAEDP) is shown to be consistent with the X-ray diffraction results. Thus, the product is tungsten disulfide.

The nanosheet tungsten disulfide was added to base oil of polyalphaolefin (PAO6) or/and diisooctyl sebacate (DIOS), and the concentration of the nanosheet tungsten disulfide was 3.0 wt. %. Allow the mixture to stand for 2 months, and no precipitate was produced.

### Example 2

3.9656 g of tungsten hexachloride, 25 g of oleylamine, 10 g of octadecene, and 1.5026 g of thioacetamide were added to a 500-mL flask. The resulting mixture was heated to 120° C., held for 10 min. The mixture was heated to 200° C., and the temperature was held for 3 hours. The produced product was centrifuged and washed with ethyl alcohol, to yield a black semisolid paste, that is, a nanosheet tungsten disulfide.

### Example 3

3.9656 g of tungsten hexachloride, 25 g of oleylamine, 10 g of octadecene and 1.5026 g of thioacetamide were added to a 500-mL flask. The resulting mixture was heated to 140° C., held for 10 min. The mixture was heated to 200° C., and the temperature was held for 2 hours. The produced product was centrifuged and washed with ethyl alcohol, to yield a black semisolid paste, that is, a nanosheet tungsten disulfide.

### Example 4

3.9656 g of tungsten hexachloride, 25 g of stearic acid, 10 g of octadecene and 1.5026 g of thioacetamide were added to a 500-mL flask. The resulting mixture was heated to 160° C., held for 10 min. The mixture was heated to 200° C., and the temperature was held for an hour. The produced product was centrifuged and washed with ethyl alcohol, to yield a black semisolid paste, that is, a nanosheet tungsten disulfide.

### Example 5

3.9656 g of tungsten hexachloride, 25 g of oleylamine, and 1.5026 g of thioacetamide were added to a 500-mL flask. The resulting mixture was heated to 140° C., held for 10 min. The mixture was heated to 200° C., and the temperature was held for 3 hours. The produced product was centrifuged and washed with ethyl alcohol, to yield a black semisolid paste, that is, a nanosheet tungsten disulfide.

### Example 6

3.9656 g of tungsten hexachloride, 25 g of oleylamine, 10 g of octadecene and 1.5224 g of thiourea were added to a 500-mL flask. The resulting mixture was heated to 140° C., held for 10 min. The mixture was heated to 200° C., and the temperature was held for 3 hours. The produced product was centrifuged and washed with ethyl alcohol, to yield a black semisolid paste, that is, a nanosheet tungsten disulfide.

### Example 7

3.9656 g of tungsten hexachloride, 20 g of oleylamine, and 10 g of octadecene were added to a 500-mL flask. The resulting mixture was heated to 140° C., held for 10 min, followed by addition of 5 g of an oleylamine solution comprising 1.5224 g of thiourea. The mixture was heated to 200° C., and the temperature was held for 3 hours. The produced product was centrifuged and washed with ethyl alcohol, to yield a black semisolid paste, that is, a nanosheet tungsten disulfide.

### Example 8

3.9656 g of tungsten hexachloride, 20 g of stearic acid, and 10 g of octadecene were added to a 500-mL flask. The resulting mixture was heated to 140° C., held for 10 min, followed by addition of 5 g of an oleylamine solution comprising 1.5026 g of thioacetamide. The mixture was heated to 200° C., and the temperature was held for 3 hours. The produced product was centrifuged and washed with ethyl alcohol, to yield a black semisolid paste, that is, a nanosheet tungsten disulfide.

### Example 9

3.9656 g of tungsten hexachloride, 20 g of heptadecyl-amine, and 10 g of octadecene were added to a 500-mL flask. The resulting mixture was heated to 140° C., held for 10 min, followed by addition of 5 g of an oleylamine solution comprising 1.5026 g of thioacetamide. The mixture was heated to 200° C., and the temperature was held for 3 hours. The produced product was centrifuged and washed with ethyl alcohol, to yield a black semisolid paste, that is, a nanosheet tungsten disulfide.

### Example 10

3.9656 g of tungsten hexachloride, 1 g of oleylamine, 10 g of oleic acid, and 10 g of octadecene were added to a 500-mL flask. The resulting mixture was heated to 140° C., held for 10 min, followed by addition of 5 g of an oleylamine solution comprising 1.5026 g of thioacetamide. The mixture was heated to 200° C., and the temperature was held for 3 hours. The produced product was centrifuged and washed with ethyl alcohol, to yield a black semisolid paste, that is, a nanosheet tungsten disulfide.

### Example 11

3.9656 g of tungsten hexachloride, 20 g of n-octylamine, and 10 g of octadecene were added to a 500-mL flask. The resulting mixture was heated to 140° C., held for 10 min, followed by addition of 5 g of an oleylamine solution comprising 1.5026 g of thioacetamide. The mixture was heated to 200° C., and the temperature was held for 3 hours. The produced product was centrifuged and washed with ethyl alcohol, to yield a black semisolid paste, that is, a nanosheet tungsten disulfide.

### Example 12

3.9656 g of tungsten hexachloride, 20 g of oleylamine, 10 g of octadecylamine and 10 g of octadecene were added to a 500-mL flask. The resulting mixture was heated to 140° C., held for 10 min, followed by addition of 5 g of an oleylamine solution comprising 1.5224 g of thiourea. The mixture was heated to 200° C., and the temperature was held for 3 hours. The produced product was centrifuged and washed with ethyl alcohol, to yield a black semisolid paste, that is, a nanosheet tungsten disulfide.

### Example 13

3.9656 g of tungsten hexachloride, 20 g of octadecylamine, 10 g of oleic acid, and 10 g of octadecene were added to a 500-mL flask. The resulting mixture was heated to 140° C., held for 10 min, followed by addition of 5 g of an oleylamine solution comprising 1.5026 g of thioacetamide. The mixture was heated to 200° C., and the temperature was held for 3 hours. The produced product was centrifuged and washed with ethyl alcohol, to yield a black semisolid paste, that is, a nanosheet tungsten disulfide.

The nanosheet tungsten disulfides prepared in Examples 2 to 13 were determined by XRD and transmission electron microscopy. It was found that the products obtained were of high purity and were nanosheet tungsten disulfides with uniform particle sizes and two-dimensional lamellar structure. The nanosheet tungsten disulfides were added to polyalphaolefin 6 (PAO6) or/and diisooctyl sebacate (DIOS), and the concentration of the nanosheet tungsten disulfide was 2.0 wt. %. Allow the mixture to stand for 2 months, and no precipitate was produced.

It will be obvious to those skilled in the art that changes and modifications may be made, and therefore, the aim in the appended claims is to cover all such changes and modifications.

What is claimed is:

1. A method, comprising:
heating a mixture comprising tungsten hexachloride, a sulfur source, and a surface modifier to a temperature of between 100 and 200° C. for at least 60 min;
wherein:
the sulfur source is thioacetamide or thiourea; and
the surface modifier is a C₆₋₄₀ straight-chain or branched fatty acid, aliphatic amine, or a mixture thereof.

2. The method of claim 1, wherein a molar ratio of the tungsten hexachloride to the thioacetamide or thiourea is 1:2, and a weight ratio of the tungsten hexachloride to the surface modifier is 1:50.
